(19) United States
(12) Patent Application Publication
(10) Pub. No.: US 2008/0257566 A1
(43) Pub. Date: Oct. 23, 2008

(54) PORTABLE LIFE PROTECTION APPARATUS, SYSTEM AND METHOD

(76) Inventor: Randy Shattuck, Greenfield Center, NY (US)

Correspondence Address: SCHMEISER, OLSEN & WATTS, 22 CENTURY HILL DRIVE, SUITE 302, LATHAM, NY, 12110, US

(21) Appl. No.: 12/105,396

(22) Filed: Apr. 18, 2008

Related U.S. Application Data
(60) Provisional application No. 60/912,814, filed on Apr. 19, 2007.

(51) Int. Cl. A62C 37/36; A62C 2/24; A62C 13/76

(52) U.S. Cl. 169/46; 169/61; 169/23; 169/26; 169/30; 169/52

(57) ABSTRACT

Provided is a portable life protection apparatus comprising: a portable unit; a fire sensor attached to the portable unit; a fire alarm in communication with the fire sensor; a fire retardant material dispenser in communication with the fire sensor; and a reservoir of fire retardant material connected to the fire retardant material dispenser. A corresponding method for protecting life through operation of the life protection apparatus is also provided.

This application hereby claims the benefit of U.S. Provisional Application No. 60/912,814 filed Apr. 19, 2007, the contents of which are hereby incorporated herein by reference in their entirety.

### BACKGROUND OF THE INVENTION

1. Technical Field

This invention relates generally to an apparatus, system and method for providing life protection. More particularly, this invention provides an apparatus comprising a self-contained, self-sustaining, portable and reliable apparatus having multiple life protection systems and corresponding methods of use.

2. Related Art

Various hazards such as fire, carbon monoxide poisoning and radon exposure pose substantial risk of injury and/or death to numerous building occupants annually. Home fires kill thousands of people every year. Carbon monoxide poisoning is a leading cause of accidental death. And, potential exposure to odorless and transparent radon is a problem persistent with many building structures throughout the world. Although devices and systems have been provided to help warn occupants of impending hazards, or help counteract and prevent the hazards when they occur, such devices and systems are prone to malfunction or failure due to neglect or power loss, water loss, or overall poor design. Malfunction or failure of such common systems defeats the very purpose for which they are provided; to warn of and ward off hazards.

Accordingly, there is a need for self-contained, self-sustaining, portable and reliable life protection apparatus, system and method.

### SUMMARY OF THE INVENTION

A first aspect of the present invention is a portable life protection apparatus comprising: a portable unit; a fire sensor attached to the portable unit; a fire alarm in communication with the fire sensor; a fire retardant material dispenser in communication with the fire sensor; and a reservoir of fire retardant material connected to the fire retardant material dispenser.

A second aspect of the present invention is a portable life protection apparatus comprising: a fire sensor in communication with a fire alarm and a fire retardant material dispenser, the fire sensor, fire alarm, and fire retardant material dispenser operably connected to a unit having portability, wherein, when the fire sensor senses a fire, the sensor communicates with the fire alarm and fire retardant material dispenser to activate the alarm and initiate dispensing of fire retardant material.

A third aspect of the present invention provides a method for life protection comprising: providing a portable life protection apparatus including: a fire sensor; a fire alarm in communication with the fire sensor; a fire retardant material dispenser in communication with the fire sensor; and a reservoir of fire retardant material connected to the fire retardant material dispenser; sensing a fire condition by the fire sensor; communicating a signal from the fire sensor to the fire alarm to activate the alarm, when a fire condition is sensed; sensing a fire by the fire sensor; communicating a signal from the fire sensor to the fire retardant material dispenser to activate the fire retardant material dispenser when a fire is sensed; protecting life by warning of fire risk when the fire alarm is activated due to a sensed fire condition; and protecting life by dispensing fire retardant material from the fire retardant material dispenser to quench a sensed fire.

### BRIEF DESCRIPTION OF THE DRAWINGS

Some embodiments of this invention will be described in detail, with reference to the following figures, wherein like designations denote like members, wherein:

FIG. 1 is a perspective view of an embodiment of a portable life protection apparatus, in accordance with the present invention;

FIG. 2 is a front view of an embodiment of a portable life protection apparatus, in accordance with the present invention.

FIG. 3 is a perspective view of another embodiment of a portable life protection apparatus removably mounted to a wall, in accordance with the present invention.

### DETAILED DESCRIPTION OF THE INVENTION

Although certain embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

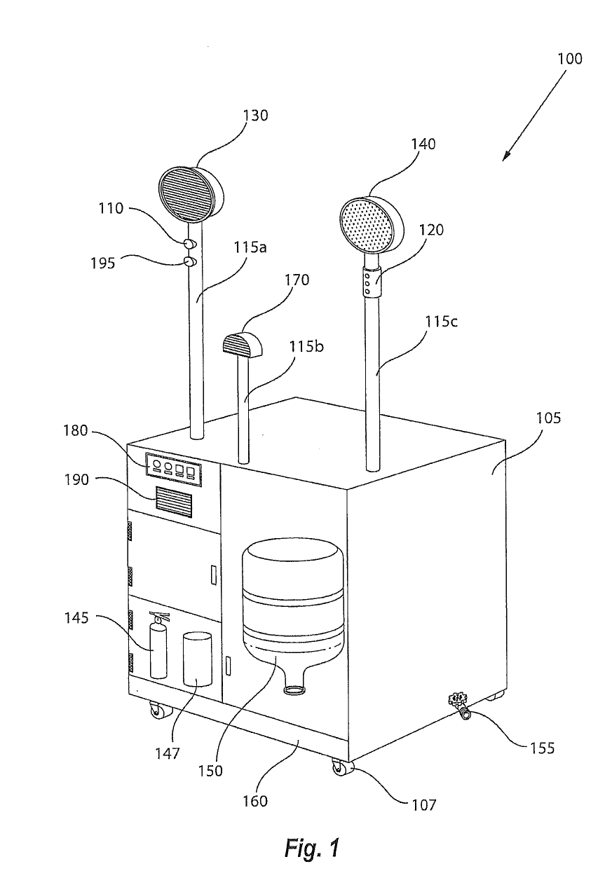

Referring to the drawings, FIG. 1 depicts a perspective view of a portable life protection apparatus 100, in accordance with the present invention. A portable life protection apparatus 100 may be moveable. For instance, the protection apparatus 100 may be placed in a bedroom of a residential dwelling for a period of time and then later moved to the corner of an office at a commercial facility. The protection device 100 comprises a unit 105. The unit 105 may include a liquid and heat resistant casing so that the apparatus may withstand heat from a fire and also withstand exposure to liquids such as water. Helping to support the unit 105 may be wheels that help facilitate movability of the protection apparatus 100. Although the unit is shown having a generally box-like shape, those in the art should appreciate that other shapes, such as cylindrical, semispherical, pyramidal, etc., may by incorporated into the unit 105 design.

A portable life protection apparatus 100 further includes a fire sensor, such as a smoke detector 110. A fire sensor, such as a smoke detector 110, may be able to sense a fire condition, such as the accumulation of smoke in a room housing the portable life protection apparatus 100. If there is a build up of smoke, there may be a fire in or near the room or there may be hazardous conditions causing smoke, wherein the hazardous conditions may lead to a fire. The fire sensor, such as a smoke detector 110 may be in communication with a fire alarm, such as a smoke alarm 130. The smoke alarm 130 may be operable to produce a loud audible noise when smoke is detected. Further alarm mechanisms may include flashing lights, LED's, or lasers that emanate from the smoke alarm when smoke is detected. The communication between the fire sensor, such as a smoke detector 110 and the fire alarm, such as a smoke alarm 130, may be through sonic or electromagnetic means. For instance, wires may join the alarm 130 to the detector 110 or the communications may be wireless. Moreover, the fire alarm, such as a smoke alarm 130, may house the fire sensor, such as a smoke detector 110, such that the smoke alarm 130 and smoke detector 110 are embodied in one integral component.

A portable life protection apparatus 100 may also include a fire sensor, such as a heat detector 120. A fire sensor, such as a heat detector 120, may be able to sense a fire condition, such as the build up of heat in a room housing the portable life protection apparatus 100. If there is significant increase in temperature, there may be a fire in or near the room or there may be hazardous conditions causing substantial heat, wherein heat associated with the hazardous conditions may lead to a fire. The fire sensor, such as a heat detector 120 may be in communication with a fire alarm, such as a smoke alarm 130, or a fire alarm, such as a life light 170. The life light 170 may be operable to produce a very bright light when heat is detected by the fire sensor, such as heat detector 120. Moreover, the fire alarm, such as a life light 170, may also be activated when smoke is detected by a fire sensor, such as smoke detector 110. Furthermore, the fire sensor, such as a heat detector 120 may be in communication with a fire retardant material dispenser 140. Still further, the fire sensor, such as heat detector 120, may also be in communication with a fire alarm, such as smoke alarm 130. The communication between the fire sensor, such as a heat detector 120 and a fire alarm, such as a life light 170 and/or a smoke alarm 130, may be through sonic or electromagnetic means. In addition, the communication between the fire sensor, such as heat detector 120, and the fire retardant material dispenser 140 may be through sonic or electromagnetic means. For instance, wires may join the material dispenser 140 to the heat detector 120 or the communications may be wireless.

The life light 170 may include incandescent, florescent, or luminescent lighting elements and may include light emitting diodes LED's and/or lasers. When turned on, the life light 170 may flash intermittently or may remain on constantly. The light from the life light 170 may emanate in all directions, may be focused in a particular direction, or may be movably focused in directions, such as by rotating a lens. The light from the life light 170 should be bright enough that an individual may see it during smoky conditions or during a blazing fire, so that the individual may orient themselves in the room and if necessary make their way toward the life protection apparatus 100.

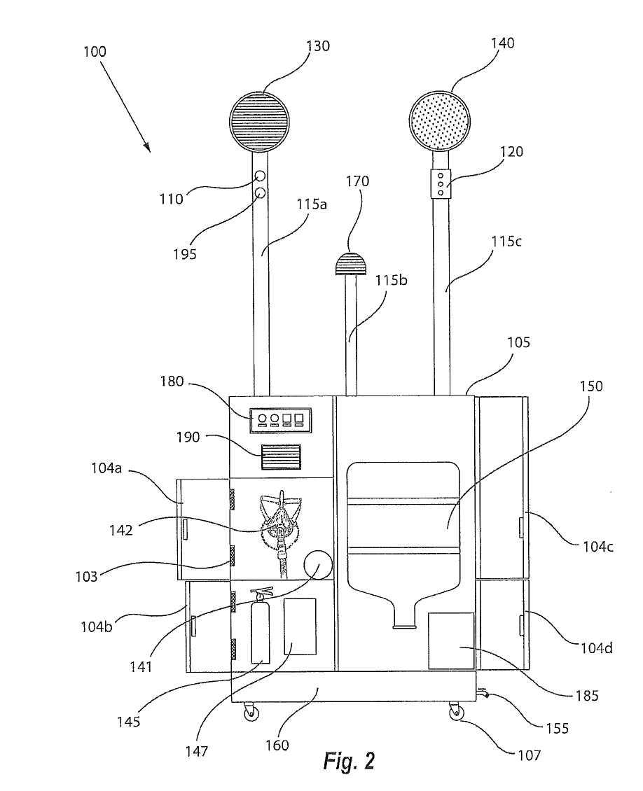

The fire retardant material dispenser 140 may be fashioned similar to a shower nozzle or a sprinkler head. The dispenser 140 should be able to dispense fire retardant material onto flames to help quench a fire. An embodiment of the dispenser 140 may be able to dispense liquids, such as water, foams, powders, or combinations thereof. The dispenser 140 is connected to a reservoir of fire retardant material, such as water. The dispenser 140 may dispense retardant material in a focused direction, through a forward facing nozzle as depicted in FIGS. 1-2. However, it should be appreciated that nozzles, sprinklers, or heads may be included to permit the dispenser 140 to dispense retardant material in all directions, multiple focused directions, or in a single moving direction, such as with a rotating head. The dispenser head should be heat and corrosion resistant so that it can withstand fire conditions and last a long time. Additionally, the fire retardant material dispenser should be designed to that the dispensing of retardant material thereby does not significantly harm building occupants seeking protective aid from the portable life protection apparatus 100.

Embodiments of a life protection apparatus 100 include a reservoir of fire retardant material. The reservoir of material may be water stored in a container 150, such as a typical 16″ by 11″ 5-gallon water jug, or the reservoir may include other materials and may be held in any structure having an interior volume configured to retain the retardant materials. Moreover, the reservoir may be held in pipes of a pre-existing water system of a building. For example, a pre-existing water system, such as plumbing in a wall of a building, may be attached with a hose and fixture to a spigot 155 of the life protection apparatus 100 to provide additional water supply to the life protection apparatus 100. However, the life protection apparatus 100 includes an internal reservoir, such as the water held in a 5-gallon jug that may be dispensed by the dispenser without reliance on exterior water supplies. Thus, even if a pre-existing water supply fails or becomes otherwise unavailable, the life protection apparatus 100 may still be able to quench a sensed fire with the fire retardant material dispensed from its internal reservoir.

As depicted in FIG. 2, and with further reference to FIG. 1, the fire sensors, such as the smoke detector 110 and the heat detector 120, along with the fire alarms, such as the life light 170 and the smoke alarm 130, may be located on extension members 115a, 115b, and 115c. Moreover, fire retardant material may be dispensed from a nozzle of the fire retardant materials dispenser 140 located on an extension member, such as extension member 115c. The extension members may be collapsible to provide more efficient transportability of the portable life protection apparatus 100.

A portion of the unit 105 may include a control panel 180 having various gauges and controls to operate and/or monitor the portable life protection apparatus. For example, the control panel may include a power meter to indicate the power supply level of a battery 160. Moreover, the control panel 180 may include a processor operable to process signals from the fire sensors, such as the smoke detector 110 or heat detector 120. Additionally, the processor may process signals related to a carbon monoxide detector 190. Accordingly, if the carbon monoxide detector 190 senses that the level of carbon monoxide is too high, then the detector 190 may send a signal to the processor. The processor may process the signal and in turn send a signal to an alarm, such as the life light 170 or the audible element of the smoke alarm 130, the sent signal directing the alarm go off and alert building occupants of the hazardous level of carbon monoxide. Similarly, the control panel may process or relay signals related to a radon detector 195. Accordingly, if the radon detector 195 senses that the level of radon gas is too high, then the detector 195 may send a signal to the control panel 180. The a processor of the control panel 180 may process the signal and in turn send a signal to an alarm, such as the life light 170 or the audible element of the smoke alarm 130, the sent signal directing the alarm to go off and alert building occupants of the hazardous level of carbon monoxide. Furthermore, the control panel may simply relay signals between sensors and alarms. The control panel may include a clock, a calendar, and a display capable of depicting images or text. The images or text may be depicted on the display as instructions to help a user of the life protection apparatus 100 know how to adequately place, operate, and maintain the protection apparatus 100. Still further, the control panel 180 may include power (on/off) switches or controls to activate various subsystems, such as sensors, alarms, or dispensers, of the apparatus 100 for testing purposes.

Embodiments of a portable life protection apparatus 100 may be communicatively linked to emergency response entities. For example the control panel 180 may include a wireless cell phone capable of dialing 911 and opening up communications with an operator. The control panel phone may be connected through a normal phone jack to a standard telecommunications infrastructure system to enable the apparatus 100 to facilitate emergency phone calls also. Accordingly, the control panel 180 may include a speaker and a microphone. Moreover, the control panel may send a coded digital transmission (wirelessly or through hard-wires) to computers of emergency response personal who may read a corresponding pre-coded message indicating location of the protection apparatus 100 and the reason the transmission was sent, such as activation of an alarm, such as a life light 170, because of unsafe conditions, such as high carbon monoxide levels as sensed by carbon monoxide detector 190. The control panel 180 may include a GPS receiver, transmitter, and/or processor.

The portable life protection apparatus 100 may include a battery 160. As depicted the battery 160 may be located in the bottom portion of the unit 105. However, those in the art should appreciate that the battery may be located anywhere in or on the unit 105. Moreover, the battery 160 may be located separate from the unit 105 and connected electrically thereto. The battery 160 may be rechargeable. For instance, standard plugs may be coupled to the battery 160 permitting the battery 160 to be plugged into a standard electrical outlet on the wall of a typical residential or commercial building. The battery 160 may in an operable manner draw charge from 120 v A/C current. Those in the art should appreciate that the life protection apparatus 100 may be designed to draw power from typical power supplies other than 120 v A/C power, such as electrical infrastructure relative to countries other than the United States. The battery 160 is designed to supply power immediately if 120 v A/C current becomes unavailable. Accordingly, the life protection apparatus 100 may utilize standard electrical power from standard electrical infrastructure, but be able draw power from the battery 160 if needed, thereby providing constant workability. The battery 160 may be removable from the unit 105.

In addition to the internal reservoir, such as the water housed within the typical 5-gallon bottle 150, a unit 105 of the portable life protection device may house other components. The life protection apparatus 100 may include a pump 185 housed within the unit 105. The pump 185 may be in fluid communication with the reservoir of water stored in the 5-gallon bottle 150. Moreover, the pump 185 may be in communication with the fire retardant material dispenser 140. The pump 185 may be an integral part of the fire retardant material dispenser. However, the pump may also be removable from the unit 105. The pump 185, when activated, operates to pump fire retardant material, such as water from the reservoir in the 5-gallon bottle and out of the fire retardant material dispenser 140. The pump 185 should be strong enough to dispense the material about the protection apparatus 100 to help quench any nearby flames. For example, the pump 185 may be strong enough to dispense material between 0-40 feet from a nozzle of the fire retardant material dispenser 140. The pump may be designed to start pumping quickly so as to dispense fire retardant material as soon as a fire sensor, such as the heat detector 120, detects a fire condition.

The unit 105 may house or have compartments for storage of a face mask and hose 142 connected to an air or oxygen supply, wherein the face mask may be pulled out of the unit 105 and used to provide additional air or oxygen to an occupant at risk of losing consciousness due to fire conditions which deplete oxygen or make it difficult to breath. The mask may draw air or oxygen stored in a tank 141 that is housed in the unit 105. Access to the mask and hose 142 may be achieved by opening a cabinet door 104a of the unit 105 and extracting the mask and hose 142 from the associated storage space behind the cabinet door 104a. The mask may include straps or other features to help it stay in place over a user's mouth. The control panel 180 may include components for displaying the status of the tank 141, i.e. how much oxygen is stored and how long the store in the tank should probably last

Further protection implements may be included in the portable life protection apparatus 100. The unit 105 may have compartments for storage of a fire retardant blanket 147. The fire retardant blanket 147 may be obtained from the unit 105 and used to protect against fire danger. Furthermore, the unit 105 may include a dock or storage area for a hand-operated fire extinguisher 145 that may be obtained from the unit 105 and used to quench flames. Access to the fire retardant blanket 147 and the fire extinguisher 145 may be achieved by opening a cabinet door 104b of the unit 105 and extracting the blanket 147 and/or the extinguisher 145 from the associated space behind the door 104b.

The reservoir of fire retardant material, such as the water stored in the 5-gallon bottle 150 may be drained and replenished periodically if needed. The reservoir may be in fluid communication with the spigot 155, such that when the spigot valve is opened, the water may drown out of the unit 105. Moreover, the entire reservoir, such as the 5-gallon water bottle 150, may be removable. Hence the 5-gallon container 150 may be drained and taken out for maintenance or during transport of the life protection apparatus 100. The internal reservoir, such as the 5-gallon container, may be accessed through cabinet doors 104c and 104d. In addition, the pump 185 may be serviced or removed through cabinet doors 104c and/or 104d. The cabinet doors may be transparent, as depicted in FIGS. 1-2, to help users quickly identify components housed within the unit 105. However, the cabinet doors may also be translucent or opaque. The body of the unit 105 should be sturdy and able to withstand impact by falling debris that may occur during a fire. Moreover, the unit 105 should be corrosion resistant.

Referring to the drawings, FIG. 1 depicts a perspective view of another embodiment of a portable life protection apparatus 200, in accordance with the present invention. A portable life protection apparatus 200 may be removably mounted on a wall. For instance, the protection apparatus 200 may be placed in the top corner of a bedroom of a residential dwelling by mounting it to the wall for a period of time and then later removed and then remounted to the top corner of an office at a commercial facility. The protection device 200 comprises a unit 205. The unit 205 may include a liquid and heat resistant casing so that the apparatus 200 may withstand heat from a fire and also withstand exposure to liquids such as water. Helping to support the unit 205 may be a wall mount bracket 206 that help facilitate removable mounting and portability of the protection apparatus 200. Removable mounting may entail sliding, snapping, clicking, or otherwise positioning the apparatus into a secure position with the wall mount bracket 206. Wall mount brackets may be designed to remain attached to a wall, while the rest of the apparatus may be readily slid off the bracket, unsnapped, unclicked, or otherwise removed from the bracket to be transported to another location. At the other location, such as a different room in a building, there may be a wall mount bracket 206 attached to a wall, to which the apparatus 200 may be removably secured. Although the unit is shown having a generally box-like shape, those in the art should appreciate that other shapes, such as cylindrical, semispherical, pyramidal, etc., may by incorporated into the unit 205 design. The unit 205 may have an attached handle 207 assisting handheld portability of the apparatus 200 before or after it has been removably mounted to a wall. Those in the art should appreciate that the apparatus 200 may be positioned on the floor or on a table or other article of furniture and need not be removably mounted to a wall, as long as the operable nature of the apparatus 200 is still effectual. Portability is central to the operability of the apparatus 200 allowing the apparatus 200 to be readily positioned in any number of locations protecting a variety of building structures.

A portable life protection apparatus 200 further includes a fire sensor, such as a smoke detector 210. A fire sensor, such as a smoke detector 210, may be able to sense a fire condition, such as the accumulation of smoke in a room wherein the portable life protection apparatus 200 is removably mounted. If there is a build up of smoke there may be a fire in or near the room or there may be hazardous conditions causing smoke, wherein the hazardous conditions may lead to a fire. The fire sensor, such as a smoke detector 210 may be in communication with a fire alarm, such as a smoke alarm 230. The smoke alarm 230 may be operable to produce a loud audible noise when smoke is detected. Further alarm mechanisms may include flashing lights, LED's, or lasers that emanate from the smoke alarm when smoke is detected. The visual emanation elements of the apparatus 200 may help occupants find exits in smoky or dark conditions. For instance, the apparatus 200 may be removably mounted near an exit door, and the lights when activated by spell the word exit. The communication between the fire sensor, such as a smoke detector 210 and the fire alarm, such as a smoke alarm 230, may be through sonic or electromagnetic means. For instance, wires may join the alarm 230 to the detector 210 or the communications may be wireless. Moreover, the fire alarm, such as a smoke alarm 230, may house the fire sensor, such as a smoke detector 210, such that the smoke alarm 230 and smoke detector 210 are embodied in one integral component.

A portable life protection apparatus 200 may also include a fire sensor, such as a heat detector 220. A fire sensor, such as a heat detector 220, may be able to sense a fire condition, such as the build up of heat in a room housing the portable life protection apparatus 200. If there is significant increase in temperature, there may be a fire in or near the room or there may be hazardous conditions causing substantial heat, wherein heat associated with the hazardous conditions may lead to a fire. The fire sensor, such as a heat detector 220 may be in communication with a fire alarm, such as a smoke alarm 230, or a fire alarm, such as a life light 270. The life light 270 may be a visual emanation element and may be operable to produce a very bright light when heat is detected by the fire sensor, such as heat detector 220. Moreover, the fire alarm, such as a life light 270, may also be activated when smoke is detected by a fire sensor, such as smoke detector 210. The life light 270 may lead occupants to exits when the portable life protection apparatus 200 is removably mounted near exit doors or windows. Furthermore, the fire sensor, such as a heat detector 220 may be in communication with a fire retardant material dispenser 240. Still further, the fire sensor, such as heat detector 220, may also be in communication with a fire alarm, such as smoke alarm 230. The communication between the fire sensor, such as a heat detector 220 and a fire alarm, such as a life light 270 and/or a smoke alarm 230, may be through sonic or electromagnetic means. In addition, the communication between the fire sensor, such as heat detector 220, and the fire retardant material dispenser 240 may be through sonic or electromagnetic means. For instance, wires may join the material dispenser 240 to the heat detector 220 or the communications may be wireless.

The life light 270 may include incandescent, florescent, or luminescent lighting elements and may include light emitting diodes LED's and/or lasers. When turned on, the life light 270 may flash intermittently or may remain on constantly. The light from the life light 270 may emanate in all directions, may be focused in a particular direction, or may be movably focused in directions, such as by rotating a lens. The light from the life light 270 should be bright enough that an individual may see it during smoky conditions or during a blazing fire, so that the individual may orient themselves in the room and if necessary make their way toward the life protection apparatus 200.

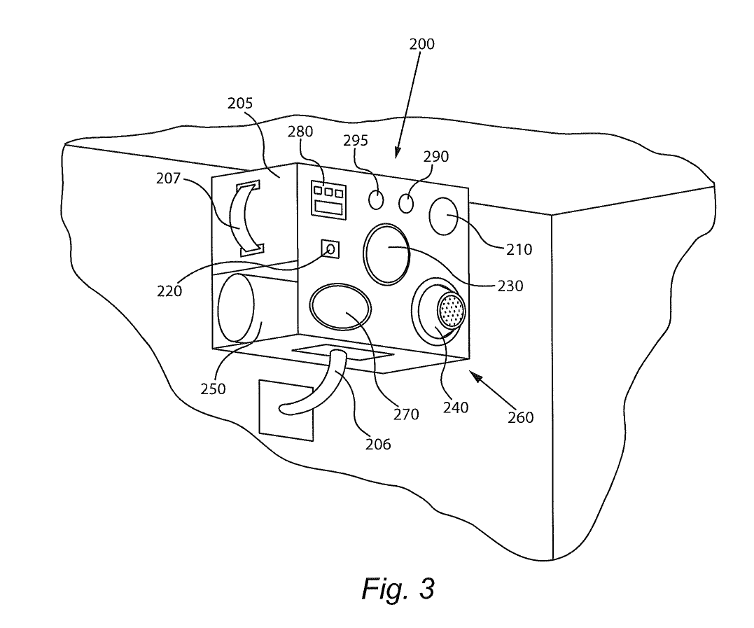

The fire retardant material dispenser 240 may be fashioned similar to a shower nozzle or a sprinkler head. The dispenser 240 should be able to dispense fire retardant material onto flames to help quench a fire. An embodiment of the dispenser 240 may be able to dispense liquids, such as water, foams, powders, or combinations thereof. The dispenser 240 is connected to a reservoir of fire retardant material, such as water or foam. The dispenser 240 may dispense retardant material in a focused direction, through a forward facing nozzle as depicted in FIG. 3. However, it should be appreciated that nozzles, sprinklers, or heads may be included to permit the dispenser 240 to dispense retardant material in all directions, multiple focused directions, or in a single moving direction, such as with a rotating head. The dispenser head should be heat and corrosion resistant so that it can withstand fire conditions and last a long time. Additionally, the fire retardant material dispenser 240 should be designed so that the dispensing of retardant material thereby does not significantly harm building occupants seeking protective aid from the portable life protection apparatus 200.

Embodiments of a life protection apparatus 200 include a reservoir of fire retardant material. The reservoir of material may be foam stored in a container 250, such as a typical cylindrical fire-extinguisher canister, or the reservoir may include other materials and may be held in any structure having an interior volume configured to retain the retardant materials. The life protection apparatus 200 includes an internal reservoir of fire retardant material that may be dispensed by the dispenser 240 without reliance on exterior water supplies.

A portion of the unit 205 may include a control panel 280 having various gauges and controls to operate and/or monitor the portable life protection apparatus. For example, the control panel may include a power meter to indicate the power supply level of a battery 260. Moreover, the control panel 280 may include a processor operable to process signals from the fire sensors, such as the smoke detector 210 or heat detector 220. Additionally, the processor may process signals related to a carbon monoxide detector 290. Accordingly, if the carbon monoxide detector 290 senses that the level of carbon monoxide is too high, then the detector 290 may send a signal to the processor. The processor may process the signal and in turn send a signal to an alarm, such as the life light 270 or the audible element of the smoke alarm 230, the sent signal directing the alarm go off and alert building occupants of the hazardous level of carbon monoxide. Similarly, the control panel may process or relay signals related to a radon detector 295. Accordingly, if the radon detector 295 senses that the level of radon gas is too high, then the detector 295 may send a signal to the control panel 280. The a processor of the control panel 280 may process the signal and in turn send a signal to an alarm, such as the life light 270 or the audible element of the smoke alarm 230, the sent signal directing the alarm to go off and alert building occupants of the hazardous level of carbon monoxide. Furthermore, the control panel may simply relay signals between sensors and alarms. The control panel may include a clock, a calendar, and a display capable of depicting images or text. The images or text may be depicted on the display as instructions to help a user of the life protection apparatus 200 know how to removably mount, operate, and maintain the protection apparatus 200. Still further, the control panel 280 may include power (on/off) switches or controls to activate various subsystems, such as sensors, alarms, or dispensers, of the apparatus 200 for testing purposes.

Embodiments of a portable life protection apparatus 200 may be communicatively linked to emergency response entities. For example the control panel 280 may include a wireless cell phone capable of dialing 911 and opening up communications with an operator. The control panel phone may be connected through a normal phone jack to a standard telecommunications infrastructure system to enable the apparatus 200 to facilitate emergency phone calls also. Accordingly, the control panel 280 may include a speaker and a microphone. Moreover, the control panel may send a coded digital transmission (wirelessly or through hard-wires) to computers of emergency response personal who may read a corresponding pre-coded message indicating location of the protection apparatus 200 and the reason the transmission was sent, such as activation of an alarm, such as a life light 270, because of unsafe conditions, such as high carbon monoxide levels as sensed by carbon monoxide detector 290. The control panel 280 may include a GPS receiver, transmitter, and/or processor, as the apparatus 200 is removably mountable and portable and may be positioned in a variety of locations.

The portable life protection apparatus 200 may include a battery 260 (not shown). Those in the art should appreciate that the battery 260 may be located anywhere in or on the unit 205. Moreover, the battery 260 may be located separate from the unit 205 and connected electrically thereto. The battery 260 may be rechargeable. For instance, standard plugs may be coupled to the battery 260 permitting the battery 260 to be plugged into a standard electrical outlet on the wall of a typical residential or commercial building. The battery 260 may in an operable manner draw charge from 120 v A/C current. Those in the art should appreciate that the life protection apparatus 200 may be designed to draw power from typical power supplies other than 120 v A/C power, such as electrical infrastructure relative to countries other than the United States. For instance, the apparatus may be removably mounted near a typical wall outlet and be plugged in to provide power and the battery 260 may serve as a backup power reserve. The battery 260 is designed to supply power immediately if 120 v A/C current becomes unavailable. Accordingly, the life protection apparatus 200 may utilize standard electrical power from standard electrical infrastructure, but be able draw power from the battery 260 if needed, thereby providing constant workability. The battery 260 may be removable from the unit 205.

The internal reservoir of fire retardant material, such as the foam housed within the typical cylindrical fire extinguisher canister 250, may be under pressure so that the fire retardant material may be ejected by the dispenser 240. The pressure should be strong enough to dispense the material about the protection apparatus 200 to help quench any nearby flames. For example, the pressure may be strong enough to dispense material between 0-40 feet from a nozzle of the fire retardant material dispenser 240.

The reservoir of pressurized fire retardant material, such as the foam stored in the typical cylindrical fire-extinguisher canister, may replenished periodically if needed. For instance, the canister of fire retardant foam may be swapped out after a pre-determined time period to assure that the fire-extinguishing capabilities of the apparatus 200 function properly. Portions of the body of the unit 205 may be transparent, as depicted in FIG. 3, to help users quickly identify components housed within the unit 205. However, the unit 205 body may also be translucent or opaque. The body of the unit 205 should be sturdy and able to withstand impact by falling debris that may occur during a fire. Moreover, the unit 205 should be corrosion resistant.

While this invention has been described in conjunction with the specific embodiments outlined above, it is evident that many alternatives, modifications and variations will be apparent to those skilled in the art. Accordingly, the embodiments of the invention as set forth above are intended to be illustrative, not limiting. Various changes may be made without departing from the spirit and scope of the invention.

What is claimed is:

1. A portable life protection apparatus comprising:
a portable unit;
a fire sensor attached to the portable unit;
a fire alarm in communication with the fire sensor;
a fire retardant material dispenser in communication with the fire sensor; and
a reservoir of fire retardant material connected to the fire retardant material dispenser.

2. The portable life protection apparatus of claim 1, further comprising a wall mounting bracket facilitating removable mounting of the apparatus to a wall.

3. The portable life protection apparatus of claim 1, wherein the reservoir of fire retardant material is foam housed within a fire extinguisher canister, the canister being removable from the portable unit.

4. The portable life protection apparatus of claim 1, further comprising a handle attached to the portable unit, the handle assisting handheld portability of the apparatus.

5. The portable life protection apparatus of claim 1, wherein the fire sensor is a smoke detector or a heat detector, and wherein the fire alarm is operable to produce a loud audible noise when heat or smoke is detected.

6. The portable life protection apparatus of claim 1, wherein the fire alarm includes a visual emanation element.

7. The portable life protection apparatus of claim 1, further comprising a control panel having various controls to operate and monitor the portable life protection apparatus, the control panel including a power meter to indicate the power supply level of a battery housed within the portable unit.

8. A portable life protection apparatus comprising:
a fire sensor in communication with a fire alarm and a fire retardant material dispenser, the fire sensor, fire alarm, and fire retardant material dispenser operably connected to a unit having portability, wherein, when the fire sensor senses a fire, the sensor communicates with the fire alarm and fire retardant material dispenser to activate the alarm and initiate dispensing of fire retardant material.

9. The portable life protection apparatus of claim 8, further comprising a wall mounting bracket facilitating removable mounting of the apparatus to a wall.

10. The portable life protection apparatus of claim 8, wherein the reservoir of fire retardant material is foam housed within a fire extinguisher canister, the canister being removable from the portable unit.

11. The portable life protection apparatus of claim 8, further comprising a carbon monoxide detector.

12. The portable life protection apparatus of claim 8, wherein the fire sensor is a smoke detector or a heat detector, and wherein the fire alarm is operable to produce a loud audible noise when heat or smoke is detected.

13. The portable life protection apparatus of claim 8, wherein the fire alarm includes a visual emanation element.

14. The portable life protection apparatus of claim 8, further comprising a control panel having various controls to operate and monitor the portable life protection apparatus, the control panel including a power meter to indicate the power supply level of a battery housed within the portable unit.

15. A method for life protection comprising:
providing a portable life protection apparatus including:
a fire sensor;
a fire alarm in communication with the fire sensor;
a fire retardant material dispenser in communication with the fire sensor; and
a reservoir of fire retardant material connected to the fire retardant material dispenser;
sensing a fire condition by the fire sensor; communicating a signal from the fire sensor to the fire alarm to activate the alarm, when a fire condition is sensed;
sensing a fire by the fire sensor; communicating a signal from the fire sensor to the fire retardant material dispenser to activate the fire retardant material dispenser when a fire is sensed;
protecting life by warning of fire risk when the fire alarm is activated due to a sensed fire condition; and
protecting life by dispensing fire retardant material from the fire retardant material dispenser to quench a sensed fire.

16. The portable life protection apparatus of claim 15, further comprising a wall mounting bracket facilitating removable mounting of the apparatus to a wall.

17. The portable life protection apparatus of claim 15, wherein the reservoir of fire retardant material is foam housed within a fire extinguisher canister, the canister being removable from the portable unit.

18. The portable life protection apparatus of claim 15, further comprising a handle attached to the portable unit, the handle assisting handheld portability of the apparatus.

19. The portable life protection apparatus of claim 15, wherein the fire sensor is a smoke detector or a heat detector, and wherein the fire alarm is operable to produce a loud audible noise when heat or smoke is detected, and wherein the fire alarm includes a visual emanation element.

20. The portable life protection apparatus of claim 15, further comprising a control panel having various controls to operate and monitor the portable life protection apparatus, the control panel including a power meter to indicate the power supply level of a battery housed within the portable unit.
